(19) United States
(12) Patent Application Publication
(10) Pub. No.: US 2026/0192483 A1
(43) Pub. Date: Jul. 9, 2026

(54) ELECTRIC STAPLER

(71) Applicant: KIHIN DO, Nagoya (JP)

(72) Inventor: KIHIN DO, Nagoya (JP)

(21) Appl. No.: 19/014,402

(22) Filed: Jan. 9, 2025

(51) Int. Cl. B27F 7/36; B31F 5/00

(52) U.S. Cl. CPC B27F 7/36; B31F 5/001

(57) ABSTRACT

An electric stapler is provided, which includes a machine base, and the machine base is provided with a bookbinding frame and a nail pressing mechanism. The nail pressing mechanism includes a nail pressing gear, a motor, and a plurality of transmission gears. The nail pressing gear is rotatably connected to the machine base through a connection shaft, and the motor drives the nail pressing gear to rotate through the plurality of transmission gears. The machine base is provided with long holes on left and right sides, and the connection shaft can move up and down in the long holes. The machine base is further provided with an auxiliary nail pressing component, which can push down against the connection shaft.

### TECHNICAL FIELD

The present disclosure relates to the field of stapler technologies, and in particular, to an electric stapler.

### BACKGROUND

Stapler is a common office stationery that is usually operated manually, which is inconvenient to use. Nowadays, electric staplers have appeared on the market, mainly including a machine base, a bookbinding frame, and a nail pressing mechanism. The nail pressing mechanism includes a nail pressing gear, a connection shaft, and a motor. The gear is set on the machine base through the connection shaft, and the nail pressing gear is provided with a roller. The center line of the roller is not coaxial with the center line of the connection shaft. When in use, the paper layer is placed into a paper inlet between the bookbinding frame and the machine base. The motor drives the nail pressing gear to rotate around the connection shaft. During a rotation of the roller driven by the nail pressing gear, the roller presses against the bookbinding frame, staples in the bookbinding frame are caused to be pressed into the paper layer.

However, the connection shaft on traditional electric staplers is rotatably provided in a circular hole on the machine base. If a thickness of the paper layer is large (more than twenty sheets of paper), the roller is difficult to push the bookbinding frame down, resulting in the roller being unable to make a complete circumferential movement around the connection shaft, ultimately causing the bookbinding frame to be unable to fully insert the staples into the paper layer. Therefore, traditional electric staplers are difficult to meet the binding requirements for thicker paper layers of more than twenty sheets.

### SUMMARY

The present disclosure addresses the shortcomings of existing technology and provides an electric stapler that uses a floated connection shaft and an auxiliary nail pressing component. A roller can smoothly move in a circumferential direction around the connection shaft, rendering the electric stapler more capable of binding thick paper layers of more than twenty sheets.

To achieve the above objectives, the present disclosure adopts the following technical solution.

An electric stapler including a machine base, where the machine base is provided with a bookbinding frame and a nail pressing mechanism; the nail pressing mechanism includes a nail pressing gear, a motor, and a plurality of transmission gears, each of the plurality of transmission gears is rotatably connected to the machine base; the nail pressing gear is rotatably connected to the machine base through a connection shaft, and the motor drives the nail pressing gear to rotate through the plurality of transmission gears, so that a roller on the nail pressing gear presses down against the bookbinding frame;
the machine base is provided with long holes on left and right sides, the long holes are extended in an up-down direction; two ends of the connection shaft are inserted into corresponding long holes, and the connection shaft is capable of moving up and down in the long holes; the connection shaft and the nail pressing gear are capable of moving up and down synchronously; a travel stroke of the connection shaft moving up and down in the long holes is 4.0 mm to 5.0 mm; the machine base is further provided with an auxiliary nail pressing component, and the auxiliary nail pressing component is capable of pushing down on the connection shaft to drive the nail pressing gear to move down and render the roller to be pressed down on the bookbinding frame; a tooth height of the nail pressing gear is 2.0 mm to 2.5 mm, a tooth height of one transmission gear that is closest to the nail pressing gear is 2.0 mm to 2.5 mm; within a travel stroke range of the connection shaft, when the nail pressing gear is moved up and down, the nail pressing gear maintains a transmission connection with the transmission gear that is closest to the nail pressing gear.

In an embodiment of the present disclosure, the auxiliary nail pressing component includes a first auxiliary nail pressing component and a second auxiliary nail pressing component, where the first auxiliary nail pressing component is connected to a left end of the connection shaft, and the second auxiliary nail pressing component is connected to a right end of the connection shaft.

In an embodiment of the present disclosure, the first auxiliary nail pressing component has a pressure spring that always causes the connection shaft to have a downward movement; an upper end of the pressure spring abuts against the machine base, and a lower end of the pressure spring abuts against the connection shaft.

In an embodiment of the present disclosure, the first auxiliary nail pressing component further includes a connection block, the machine base is provided with a first baffle corresponding to the connection block, an upper end and a lower end of the pressure spring respectively abut against the first baffle and the connection block; the connection block is connected to the connection shaft.

In an embodiment of the present disclosure, the connection block is provided with a first limit rod that is extended upward, the pressure spring is sleeved on an outer side of the first limit rod, and the first baffle has a clearance opening for the first limit rod to pass through.

In an embodiment of the present disclosure, the connection block is provided with a connection hole, and the connection shaft runs through the connection hole.

In an embodiment of the present disclosure, a horizontal distance b1 between a centerline of the connection shaft and a centerline of the transmission gear that is closest to the nail pressing gear is 28 mm to 29 mm.

In an embodiment of the present disclosure, a distance b2 between a centerline of the roller and the centerline of the connection shaft is 10 mm to 12 mm.

In an embodiment of the present disclosure, the nail pressing gear includes a first gear and a second gear; both the first gear and the second gear are rotatably connected to the machine base through the connection shaft; the roller is provided between the first gear and the second gear, and two ends of the roller in an axial direction are rotatably connected to the first gear and the second gear, respectively.

Compared with the existing technology, the present disclosure has obvious advantages and beneficial effects. Specifically, by providing long holes on left and right sides of the machine base to provide up and down movement space for the connection shaft, the nail pressing gear and the connection shaft can move up and down synchronously, and an auxiliary nail pressing component is added. When in use, the motor drives the nail pressing gear to rotate clockwise through the transmission gears, and both the nail pressing gear and the roller are rotated clockwise around the connection shaft. When the roller abuts against an upper surface of the bookbinding frame, the bookbinding frame has an upward reaction force on the roller, causing the roller, nail pressing gear, and the connection shaft to move up for a short distance. The lowest point of the roller is moved up, allowing the nail pressing gear and the roller to make a complete circumferential movement around the connection shaft. When the roller is located at the lowest point, under a combined action of a driving force of the motor and a downward pressure of the auxiliary nail pressing component, the roller presses the bookbinding frame with maximum force, allowing the bookbinding frame to press the staples into thicker layers of paper. Therefore, a floated connection shaft is used, combined with the auxiliary nail pressing component. The roller can smoothly move in the circumferential direction around the connection shaft, rendering the electric stapler having stronger binding ability. It can meet the binding of thicker layers of paper with more than twenty sheets of paper and can bind up to forty-five sheets of paper at most.

To provide a clearer explanation of the structural features, technical means, and specific objectives and functions achieved by the present disclosure, the following will further elaborate on the present disclosure in combination with the accompanying drawings and specific embodiments.

### BRIEF DESCRIPTION OF DRAWINGS

FIG. 1 is a schematic diagram of an assembly structure of the present disclosure.

FIG. 2 is a first exploded schematic diagram of the present disclosure.

FIG. 3 is a second exploded schematic diagram of the present disclosure.

FIG. 4 is a schematic diagram of a state where a connection shaft is located at a top of a long hole of the present disclosure.

FIG. 5 is a schematic diagram of a state where the connection shaft is in a middle of the long hole of the present disclosure.

FIG. 6 is a schematic diagram of a state where the connection shaft is located at a lowest end of the long hole of the present disclosure.

FIG. 7 is a schematic diagram of a usage state of the present disclosure.

Numeral reference: 10 machine base; 11 paper inlet; 12 long hole; 13 first baffle; 131 clearance opening; 20 bookbinding frame; 21 upper knife rest; 211 abutting plate; 22 lower knife rest; 23 inner shell; 30 nail pressing mechanism; 31 nail pressing gear; 311 first gear; 312 second gear; 313 roller; 32 motor; 33 transmission gear; 40 auxiliary nail pressing component; 41 first auxiliary nail pressing component; 42 second auxiliary nail pressing component; 43 pressure spring; 44 connection block; 441 connection hole; 45 first limit rod; 60 connection shaft; 70 paper layer.

### DESCRIPTION OF EMBODIMENTS

In the description of the present disclosure, it should be noted that terms “center”, “up”, “down”, “left”, “right”, “vertical”, “horizontal”, “inside”, “outside” and other directional or positional relationships indicated are based on the directional or positional relationships shown in the accompanying drawings, only for a convenience of describing the invention and simplifying the description, and do not indicate or imply that the referred position or element must have a specific orientation, be constructed and operated in a specific orientation, and therefore cannot be understood as a limitation of the present disclosure.

In the present disclosure, it should be noted that unless otherwise specified and limited, terms “installation”, “connection to”, and “connection with” should be broadly understood, for example, it can be a fixed connection, a detachable connection, or an integral connection; it can be a mechanical connection or an electrical connection; it can be directly connected, indirectly connected through an intermediate medium, or connected internally between two components. For those skilled in the art, specific meanings of the above terms in the present disclosure can be understood depending on a specific situation.

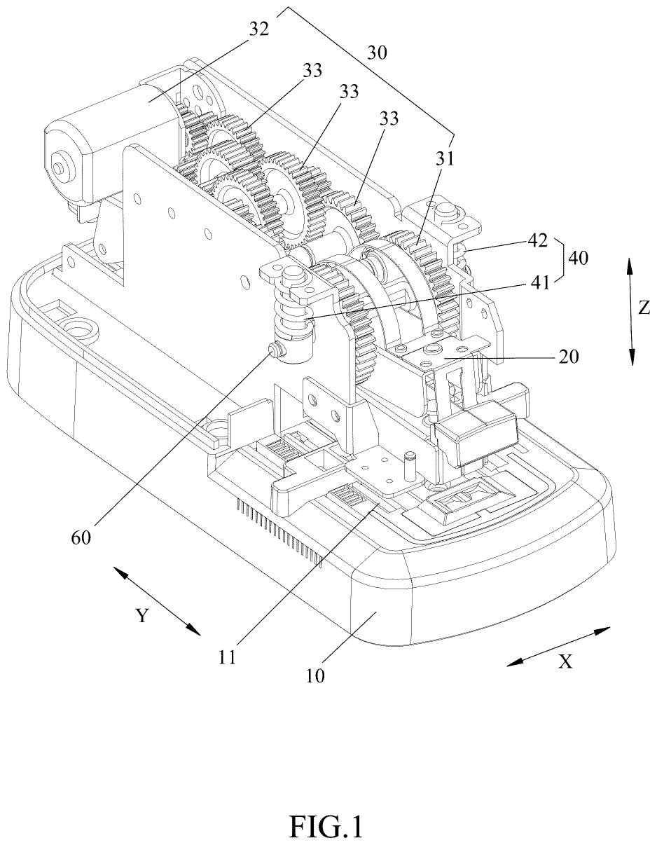

As shown in FIG. 1, for a convenience of description and understanding, label X in FIG. 1 represents a left-right direction, label Y represents a front-back direction, and label Z represents an up-down direction.

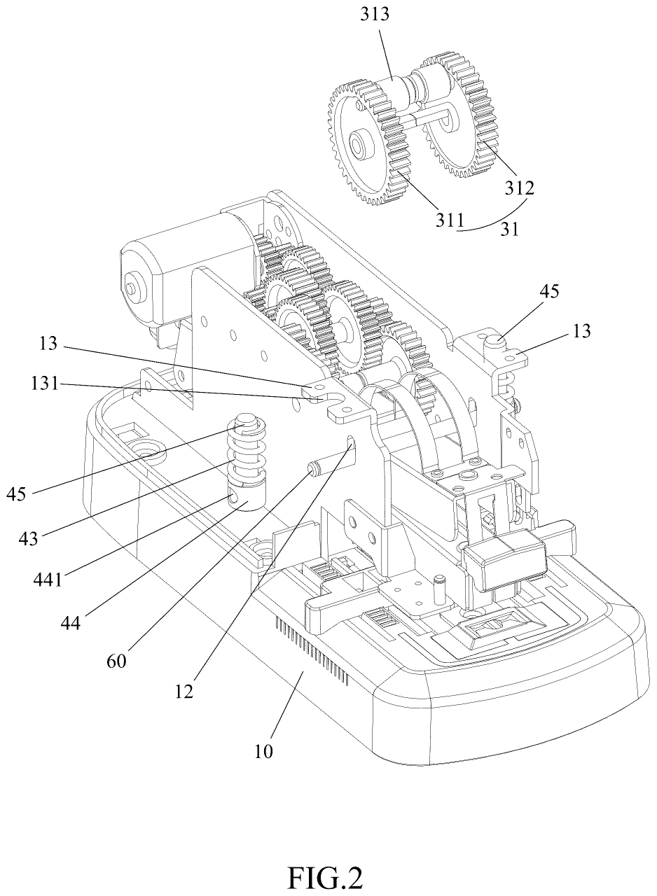

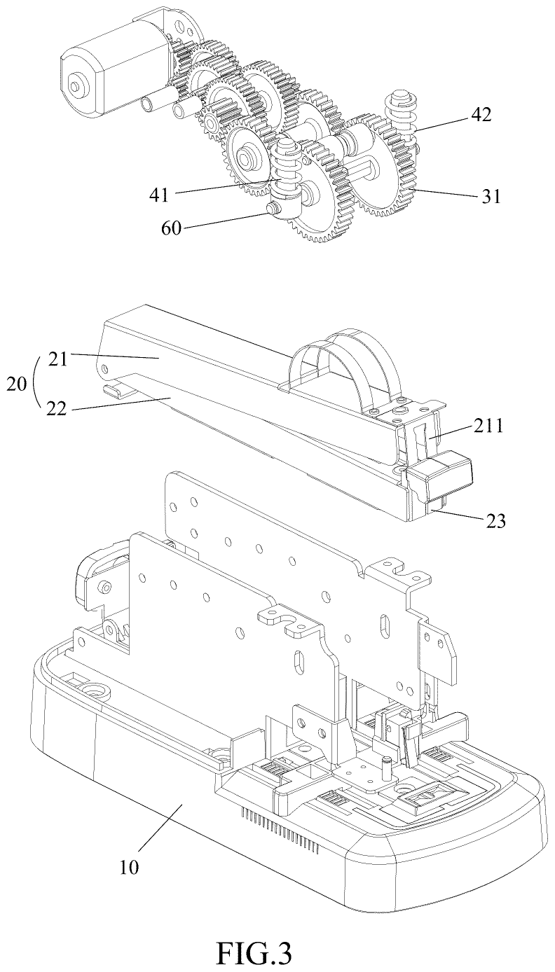

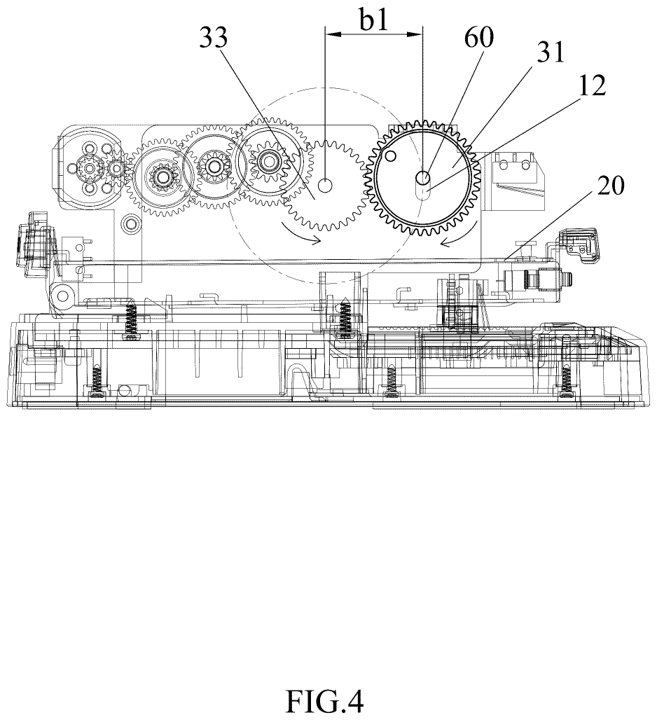

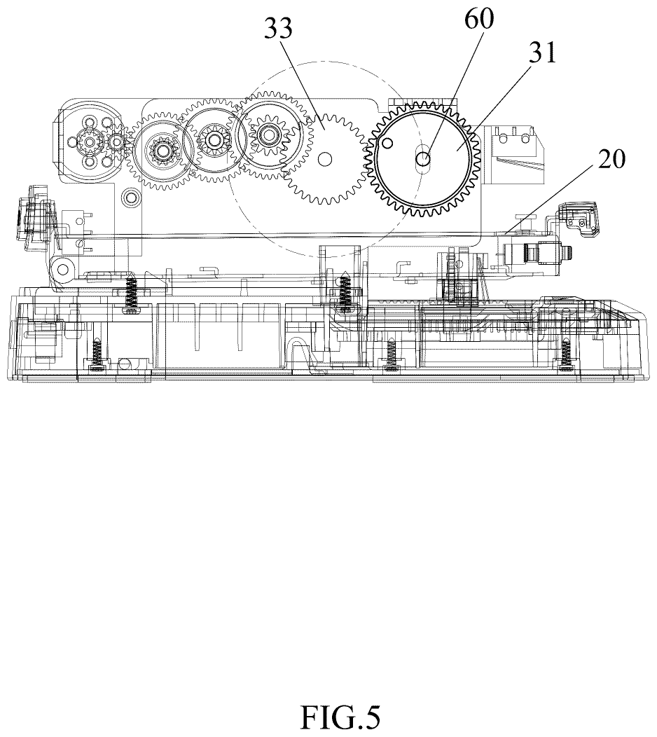

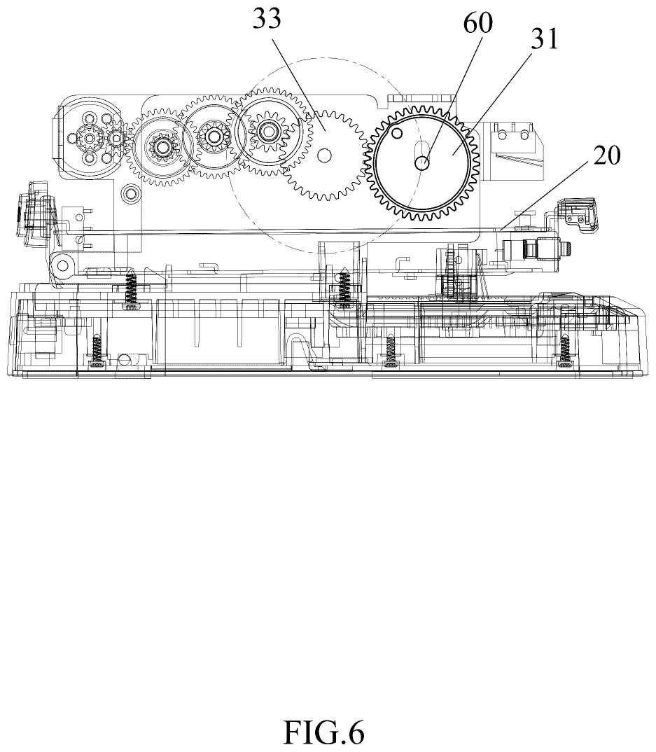

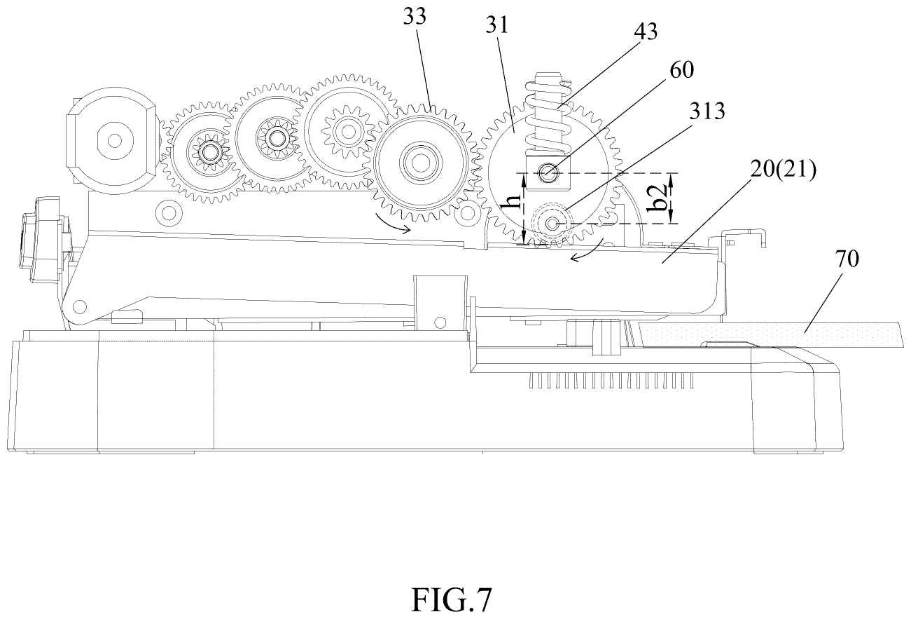

As shown in FIGS. 1-7, the present disclosure relates to an electric stapler, which includes a machine base 10, where a bookbinding frame 20 and a nail pressing mechanism 30 are provided on the machine base 10. A paper inlet 11 is formed between the bookbinding frame 20 and the machine base 10. The nail pressing mechanism 30 includes a nail pressing gear 31, a motor 32, and a plurality of transmission gears 33, each of the plurality of transmission gears 33 is rotatably connected to the machine base 10. A position of each transmission gear 33 relative to the machine base 10 remains unchanged. The nail pressing gear 31 is rotatably connected to the machine base 10 through a connection shaft 60. In an implementation mode, the nail pressing gear 31 is rotatably connected to the connection shaft 60, and the connection shaft 60 is rotatably connected to the machine base 10; and the motor 32 drives the nail pressing gear 31 to rotate by through the plurality of transmission gears 33, so that a roller 313 on the nail pressing gear 31 presses down against the bookbinding frame 20 and causes staples in the bookbinding frame 20 are pressed into a paper layer 70; the plurality of transmission gears 33 are located behind the nail pressing gear 31. Providing the plurality of transmission gears 33 can achieve an effect of reducing speed and increasing torque, thereby increasing a force of the roller 313 pressing down on the bookbinding frame 20.

The machine base 10 is provided with long holes 12 on left and right sides, the long holes 12 are extended in the up-down direction. Two ends of the connection shaft 60 are threaded through corresponding long holes 12. The connection shaft 60 can move up and down in the long holes 12 and can also be rotated inside the long holes 12. The connection shaft 60 can move up and down synchronously with the nail pressing gear 31. A travel stroke of the connection shaft 60 moving up and down in the long holes 12 is 4.0 mm to 5.0 mm, and in an implementation mode, the travel stroke of the connection shaft 60 moving up and down in the long holes 12 is 4.5 mm. The machine base 10 is further provided with an auxiliary nail pressing component 40, and the auxiliary nail pressing component 40 can push down on the connection shaft. 60, so that the connection shaft 60 drives the nail pressing gear 31 to move downward and presses the roller 313 downward against the bookbinding frame 20. A tooth height of the nail pressing gear 31 is 2.0 mm to 2.5 mm, in an implementation mode, it is 2.25 mm. A tooth height of one transmission gear 33 that is closest to the nail pressing gear 31 is 2.0 mm to 2.5 mm, in an implementation mode, it is 2.25 mm. A distance b2 between a centerline of the roller 313 and a centerline of the connection shaft 60 is 10 mm to 12 mm, in an implementation mode, it is 11 mm. Within a travel stroke range of the connection shaft 60, a horizontal distance b1 between a centerline of the connection shaft 60 and the centerline of the transmission gear 33 that is closest to the nail pressing gear 31 is 28 mm to 29 mm, in an implementation mode, it is 28.7 mm, so that when the nail pressing gear 31 is moved up and down, the nail pressing gear 31 maintains a transmission connection with the transmission gear 33 that is closest to the nail pressing gear 31.

During operation, the motor 32 drives the transmission gear 33 to rotate. The transmission gear 33 that is closest to the nail pressing gear 31 is rotated counterclockwise, the nail pressing gear 31 is caused to rotate clockwise around the connection shaft 60. The nail pressing gear 31 drives the roller 313 to rotate clockwise around the connection shaft 60. When an outer circumferential wall of the roller 313 abuts against an upper surface of the bookbinding frame 20, the roller 313 is subjected to an upward force from the bookbinding frame 20, the roller 313, the nail pressing gear 31, and the connection shaft 60 are caused to move up a short distance synchronously (the long holes 12 provide an upward space for the connection shaft 60), allowing the nail pressing gear 31 and the roller 313 to make a complete circumferential movement around the connection shaft 60. The transmission gear 33 that is closest to the nail pressing gear 31 is rotated counterclockwise. At this time, only teeth on the nail pressing gear 31 generate upward thrust, the nail pressing gear 31 is caused to rotate around the connection shaft 60. Therefore, when the nail pressing gear 31 is moved up and down. The nail pressing gear 31 will not get stuck with the transmission gear 33 that is closest to the nail pressing gear 31, and within the travel stroke range of the connection shaft 60, the teeth on the nail pressing gear 31 are still in mesh with the teeth on the transmission gear 33 that is closest to the nail pressing gear 31, which can prevent the nail pressing gear 31 from disengaging from the transmission gears 33. Therefore, the nail pressing gear 31 can maintain a transmission connection with the transmission gear 33 that is closest to the nail pressing gear 31.

The bookbinding frame 20 includes an upper knife rest 21 and a lower knife rest 22 that are arranged vertically. One ends of the upper knife rest 21 and the lower knife rest 22 are rotatably installed on the machine base 10. The lower knife rest 22 is provided with a inner shell 23 that can accommodate staples. The other end of the upper knife rest 21 is provided with a abutting plate 211. The nail pressing gear 31 includes a first gear 311 and a second gear 312; both of the first gear 311 and the second gear 312 are rotatably connected to the machine base 10 through the connection shaft 60. The roller 313 is provided between the first gear 311 and the second gear 312, two axial ends of the roller 313 are respectively rotatably connected to the first gear 311 and the second gear 312. When the nail pressing gear 31 is rotated, the nail pressing gear 31 drive the roller 313 to rotate around the connection shaft 60, so that the roller 313 presses down on the upper knife rest 21, and the abutting plate 211 presses the staples in the inner shell 23 into the paper layer 70.

The auxiliary nail pressing component 40 includes a first auxiliary nail pressing component 41 and a second auxiliary nail pressing component 42. The first auxiliary nail pressing component 41 and the second auxiliary nail pressing component 42 are respectively provided on left and right sides of the machine base 10. The first auxiliary nail pressing component 41 is connected to a left end of the connection shaft 60, and the second auxiliary nail pressing component 42 is connected to a right end of the connection shaft 60.

The first auxiliary nail pressing component 41 and the second auxiliary nail pressing component 42 both have a pressure spring 43 that always causes the connection shaft 60 to have a downward movement trend. An upper end of the pressure spring 43 abuts against the machine base 10, a lower end of the pressure spring 43 abuts against the connection shaft 60. An elastic force of the pressure spring 43 is greater than a resistance of the bookbinding frame 20 to press the staples into the paper layer 70. When the roller 313 is rotated to the lowest point, the elastic force of the pressure spring 43 acts vertically downward on the connection shaft 60, and the connection shaft 60 acts vertically downward on the roller 313. At this time, under a combined action of a driving force of the motor 32 and a maximum elastic force of the pressure spring 43, the roller 313 presses down on the bookbinding frame 20 with the maximum force, rendering the bookbinding frame 20 press down and completely drive the staples to be pressed into the thicker paper layer 70.

The first auxiliary nail pressing component 41 and the second auxiliary nail pressing component 42 both have a connection block 44. The machine base 10 is provided with a first baffle 13 corresponding to the connection block 44, the first baffle 13 is connected to the machine base 10 as a whole. The upper and lower ends of the pressure spring 43 respectively abut against the first baffle 13 and the connection block 44, and the connection block 44 is connected to the connection shaft 60.

The connection block 44 is provided with a first limit rod 45 that is extended upward, and the pressure spring 43 is sleeved on an outer side of the first limit rod 45. The first baffle 13 has a clearance opening 131 for the first limit rod 45 to pass upward, and the clearance opening 131 penetrates a side surface of the first baffle 13. The connection block 44 is provided with a connection hole 441, and the connection shaft 60 runs through the connection hole 441.

The working principle of the present disclosure: the paper layer 70 is inserted into the paper inlet 11, and the motor 32 drives the nail pressing gear 31 to rotate through the transmission gears 33. The nail pressing gear 31 drives the roller 313 to rotate clockwise around the connection shaft 60, and the roller 313 presses down against the upper knife rest 21. The upper knife rest 21 generates an upward reaction force on the roller 313, the roller 313 is caused to drive the nail pressing gear 31 and the connection shaft 60 to overcome the elastic force of the pressure spring 43 and move up synchronously for a short distance. When the connection shaft 60 is moved up, a vertical distance h between the connection shaft 60 and the bookbinding frame 20 is increased, and the lowest point of the roller 313 is moved up, allowing the roller 313 to make a complete circumferential movement around the connection shaft 60. This realizes that the roller 313 can rotate clockwise from the front to the lowest point and then rotate to the rear. At the same time, the pressure spring 43 always pushes the connection shaft 60 downwards. When the roller 313 is located at the lowest point, under a combined action of the motor 32 and the pressure spring 43, the roller 313 presses down with maximum force on the upper knife rest 21, and the upper knife rest 21 presses the staples in inner shell 23 into paper layer 70.

In summary, the present disclosure provides up and down movement space for the connection shaft 60 by providing long holes 12 on left and right sides of the machine base 10. The nail pressing gear 31 and the connection shaft 60 can move up and down synchronously, and the auxiliary nail pressing component 40 is added. When in use, the motor 32 drives the nail pressing gear 31 to rotate clockwise through the transmission gear 33. During a clockwise rotation of the nail pressing gear 31 and the roller 313 around the connection shaft 60, when the roller 313 abuts against an upper surface of the bookbinding frame 20, the bookbinding frame 20 has an upward reaction force on the roller 313, the roller 313, the nail pressing gear 31, and the connection shaft 60 are caused to move upward for a short distance. The lowest point of the roller 313 is moved upward, allowing the nail pressing gear 31 and the roller 313 to make a complete circumferential movement around the connection shaft. When the roller 313 is located at the lowest point, under a combined action of a driving force of the motor 32 and a downward pressure of the auxiliary nail pressing component 40, the roller 313 presses the bookbinding frame 20 with maximum force, allowing the bookbinding frame 20 to press the staples into the thicker paper layer 70. Therefore, a floated connection shaft 60 is used, combined with the auxiliary nail pressing component 40. The roller 313 can smoothly move in the circumferential direction around the connection shaft 60, rendering the electric stapler having stronger binding ability, it can perform binding of thicker paper layers 70 with more than twenty sheets of paper and can bind up to forty-five sheets of paper at most.

The above description is only preferred embodiments of the present disclosure and is not intended to limit the present disclosure. Therefore, any modifications, equivalent substitutions, improvements, etc. made to the above embodiments based on the actual technology of the present disclosure still fall within the scope of the disclosed technical solution.

1. An electric stapler, comprising a machine base, wherein the machine base is provided with a bookbinding frame and a nail pressing mechanism;
wherein the nail pressing mechanism comprises a nail pressing gear, a motor, and a plurality of transmission gears, each of the plurality of transmission gears being rotatably connected to the machine base;
wherein the nail pressing gear is rotatably connected to the machine base through a connection shaft, and the motor drives the nail pressing gear to rotate through the plurality of transmission gears, so that a roller on the nail pressing gear presses down against the bookbinding frame;
wherein the machine base is provided with long holes on left and right sides of the machine base, the long holes being extended in an up-down direction;
wherein two ends of the connection shaft are inserted into corresponding ones of the long holes, and the connection shaft is capable of moving up and down in the long holes;
wherein the connection shaft and the nail pressing gear are capable of moving up and down synchronously;
wherein a travel stroke of the connection shaft moving up and down in the long holes is 4.0 mm to 5.0 mm;
wherein the machine base is further provided with an auxiliary nail pressing component, and the auxiliary nail pressing component is capable of pushing down on the connection shaft to drive the nail pressing gear to move down and cause the roller to be pressed down on the bookbinding frame;
wherein a tooth height of the nail pressing gear is 2.0 mm to 2.5 mm;
wherein a tooth height of one of the transmission gears that is closest to the nail pressing gear is 2.0 mm to 2.5 mm; and
wherein within a travel stroke range of the connection shaft, when the nail pressing gear is moved up and down, the nail pressing gear maintains a transmission connection with the one of the transmission gears that is closest to the nail pressing gear;
wherein a distance b2 between a centerline of the roller and a centerline of the connection shaft is 10 mm to 12 mm;
wherein a horizontal distance b1 between the centerline of the connection shaft and a centerline of one of the transmission gears that is closest to the nail pressing gear is 28 mm to 29 mm.

2. The electric stapler according to claim 1, wherein the auxiliary nail pressing component comprises a first auxiliary nail pressing component and a second auxiliary nail pressing component, and
wherein the first auxiliary nail pressing component is connected to a left end of the connection shaft, and the second auxiliary nail pressing component is connected to a right end of the connection shaft.

3. The electric stapler according to claim 2, wherein the first auxiliary nail pressing component has a pressure spring that always pushes the connection shaft downward; and
wherein an upper end of the pressure spring abuts against the machine base, and a lower end of the pressure spring is proximate to the connection shaft.

4. The electric stapler according to claim 3, wherein the first auxiliary nail pressing component further comprises a connection block, and
the machine base is provided with a first baffle corresponding to the connection block,
the upper end and the lower end of the pressure spring respectively abut against the first baffle and the connection block;
the connection block is connected to the connection shaft.

5. The electric stapler according to claim 4, wherein the connection block is provided with a first limit rod that is extended upward,
the pressure spring is sleeved on an outer side of the first limit rod, and the first baffle has a clearance opening for the first limit rod to pass through.

6. The electric stapler according to claim 4, wherein the connection block is provided with a connection hole, and the connection shaft runs through the connection hole.

7-8. (canceled)

9. The electric stapler according to claim 1, wherein the nail pressing gear comprises a first gear and a second gear, both the first gear and the second gear are rotatably connected to the machine base through the connection shaft,
the roller is provided between the first gear and the second gear, and two ends of the roller in an axial direction are rotatably connected to the first gear and the second gear, respectively.
